(19) United States
(12) Patent Application Publication
(10) Pub. No.: US 2013/0159144 A1
(43) Pub. Date: Jun. 20, 2013

(54) SYSTEM AND METHOD FOR PROVIDING ALTERNATIVE FULFILLMENT FOR A BUYER'S UNFULFILLABLE ORDER

(71) Applicants: Krystal Rose Higgins, Sunnyvale, CA (US); Roel Ramirez, Hayward, CA (US); Margaret Szeto, Santa Clara, CA (US); Joel Robert Edelman, San Jose, CA (US); Caroline Juliet Fernandes, San Jose, CA (US); Stephen Tse, Daly City, CA (US); F Monroe Labouisse, San Carlos, CA (US); Amol Vilas Sane, San Jose, CA (US); David Grabel, Redwood City, CA (US); Zeenat Vastrad, San Jose, CA (US); Kirk Jonathan Wicks, San Jose, CA (US)

(72) Inventors: Krystal Rose Higgins, Sunnyvale, CA (US); Roel Ramirez, Hayward, CA (US); Margaret Szeto, Santa Clara, CA (US); Joel Robert Edelman, San Jose, CA (US); Caroline Juliet Fernandes, San Jose, CA (US); Stephen Tse, Daly City, CA (US); F Monroe Labouisse, San Carlos, CA (US); Amol Vilas Sane, San Jose, CA (US); David Grabel, Redwood City, CA (US); Zeenat Vastrad, San Jose, CA (US); Kirk Jonathan Wicks, San Jose, CA (US)

(73) Assignee: eBay Inc., San Jose, CA (US)

(21) Appl. No.: 13/325,994

(22) Filed: Dec. 14, 2011

(51) Int. Cl. G06Q 30/06

(52) U.S. Cl. 705/26.81

(57) ABSTRACT

A method and a system for providing an alternative fulfillment for a buyer's unfulfilled order are described. The system has an order fulfillment issue detection module, an alternative fulfillment qualification module, a replacement item matching module, and a replacement item order module. The order fulfillment issue detection module detects a fulfillment delay of an item in an order placed in an online marketplace. The alternative fulfillment qualification module determines whether the fulfillment delay qualifies for an alternative fulfillment order. The replacement matching module determines a replacement item for the item. The replacement item order module cancels the order and replaces the order with the alternative fulfillment order for the replacement item.

### TECHNICAL FIELD

This application relates generally to the field of computer technology, and in a specific example embodiment, to a system and method for providing alternative fulfillment for a buyer's unfulfilled order.

### BACKGROUND

Websites provide a number of publishing, listing, and price-setting mechanisms whereby a publisher (e.g., a seller) may list or publish information concerning items for sale. Once a buyer places an order for an item, the seller fulfills the order by shipping the item to the buyer. However, delays in the shipment of the item can occur and can result in the buyer's frustration. In another scenario, the shipment may get lost. As a result, the buyer reorders the item.

### BRIEF DESCRIPTION OF THE DRAWINGS

The present description is illustrated by way of example, and not by way of limitation, in the figures of the accompanying drawings in which:

FIG. 1 is a network diagram depicting a network system, according to one embodiment, having a client-server architecture configured for exchanging data over a network;

FIG. 2 is a block diagram illustrating an example embodiment of an alternative fulfillment application;

FIG. 3 is a block diagram illustrating an example embodiment of an order fulfillment issue detection module;

FIG. 4 is a block diagram illustrating an example embodiment of an alternative fulfillment qualification module;

FIG. 5 is a block diagram illustrating an example embodiment of a replacement item matching module;

FIG. 6 is a block diagram illustrating an example embodiment of a replacement item order module;

FIG. 7 is a flow chart of one embodiment of a method for providing an alternative fulfillment order;

FIG. 8 is a flow chart of one embodiment of a method for detecting an order fulfillment issue;

FIG. 9 is a flow chart of one embodiment of a method for determining an alternative fulfillment qualification;

FIG. 10 is a flow chart of one embodiment of a method for determining matching replacement items;

FIG. 11 is a flow chart of an example of a method for replacing an order with an alternative fulfillment order;

FIG. 12 shows a diagrammatic representation of machine in the example form of a computer system within which a set of instructions may be executed to cause the machine to perform any one or more of the methodologies discussed herein;

FIG. 13 is a screenshot of one embodiment of an order detail page with notification options;

FIG. 14A is a screenshot of one embodiment of a notification of a shipping delay;

FIG. 14B is a screenshot of an example order information screen with options for replacing or canceling a delayed order;

FIG. 14C is a screenshot of an example order replacement option screen;

FIG. 14D is a screenshot of an example replacement information screen for an item to be shipped by an alternative seller;

FIG. 14E is a screenshot of an example order replacement information screen for an item to be provided by a local physical store;

FIG. 14F is a screenshot of an example order replacement confirmation screen for an item the user has selected provided by an alternative seller; and

FIG. 14G is a screenshot of an example order replacement confirmation receipt for an item to be picked up at a local physical store.

### DETAILED DESCRIPTION

Although the embodiments have been described with reference to specific example embodiments, it will be evident that various modifications and changes may be made to these embodiments without departing from the broader spirit and scope of the description. Accordingly, the specification and drawings are to be regarded in an illustrative rather than a restrictive sense.

In various embodiments, a method and a system for providing an alternative fulfillment for a buyer's unfulfillable order are described. The system has an order fulfillment issue detection module, an alternative fulfillment qualification module, a replacement item matching module, and a replacement item order module. The order fulfillment issue detection module detects a fulfillment delay of an item in an order placed in an online marketplace. The alternative fulfillment qualification module determines whether the fulfillment delay qualifies for an alternative fulfillment order. The replacement item matching module determines a replacement item for the item. The replacement item order module cancels the order and replaces the order with the alternative fulfillment order for the replacement item with an alternative seller.

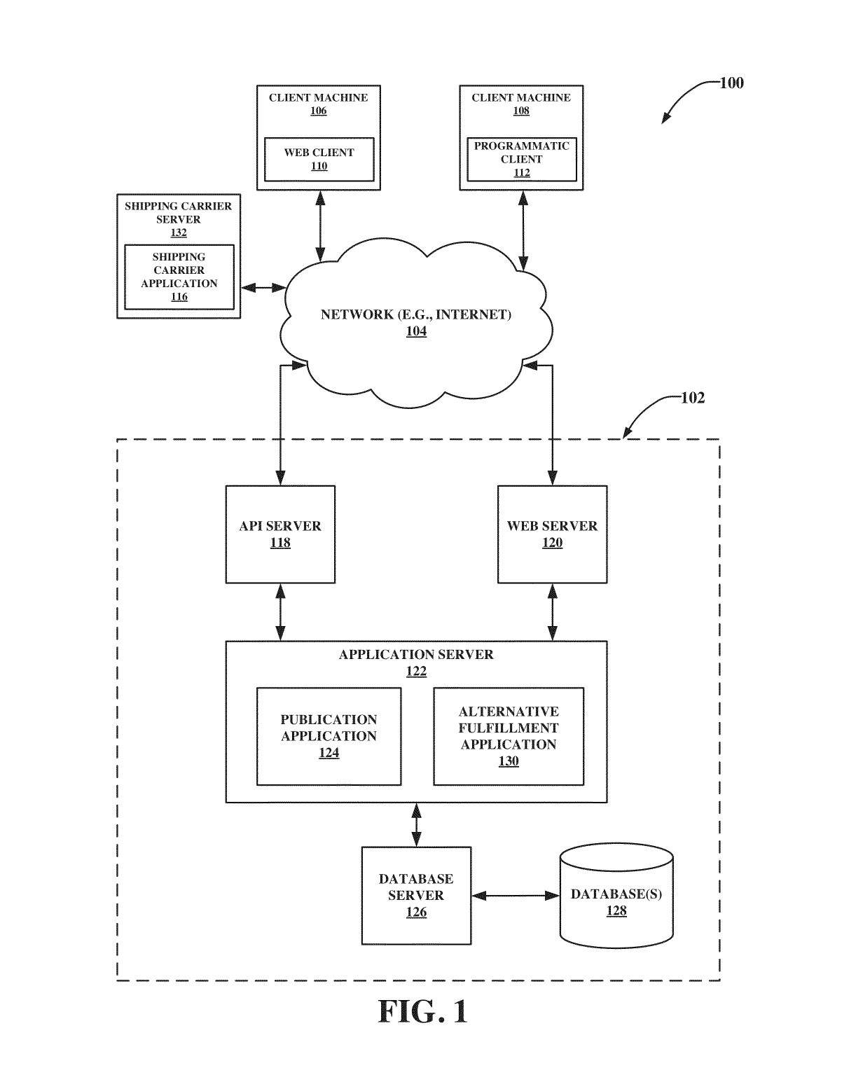

FIG. 1 is a network diagram depicting a network system 100, according to one embodiment, having a client-server architecture configured for exchanging data over a network. For example, the network system 100 may be a publication/publisher system 102 where clients may communicate and exchange data within the network system 100. The data may pertain to various functions online item purchases) and aspects (e.g., managing order information) associated with the network system 100 and its users. Although illustrated herein as a client-server architecture as an example, other embodiments may include other network architectures, such as a peer-to-peer or distributed network environment.

A data exchange platform, in an example form of a network-based publisher 102, may provide server-side functionality, via a network 104 (e.g., the Internet), to one or more clients. The one or more clients may include users that utilize the network system 100 and more specifically, the publication/publisher system 102, to exchange data over the network 104. These transactions may include transmitting, receiving (communicating) and processing data to, from, and regarding content and users of the network system 100. The data may include, but are not limited to, content and user data such as order tracking information; alternative fulfillment data; feedback data; user reputation values; user profiles; user attributes; product and service reviews and information, such as pricing and descriptive information; product, service, manufacturer, and vendor recommendations and identifiers; product and service listings associated with buyers and sellers; auction bids; and transaction data, among other things.

In various embodiments, the data exchanges within the network system 100 may be dependent upon user-selected functions available through one or more client or user interfaces (Ms). The UIs may be associated with a client machine, such as a client machine 106 using a web client (e.g., web browser) 110. The web client 110 may be in communication with the network-based publisher 102 via a web server 120. The UIs may also be associated with a client machine 108 using a programmatic client 112, such as a client application. It can be appreciated that in various embodiments, the client machines 106 and 108 may be associated with a buyer, a seller, a third party electronic commerce platform, and/or a payment service provider. The buyers and sellers may be any one of individuals, merchants, or service providers, among other things.

Furthermore, a shipping carrier server 132 of a shipping service provider may be in communication with the network-based publisher 102 and optionally with client machines 106 and 108. The shipping carrier server 132 includes a shipping carrier application 116 to provide a shipping tracking mechanism to the client machines 106 and 108 and the application server 122. The shipping tracking mechanism allows the client machines 106 and 108 and the application server 122 to determine the status of a shipment for an item associated with an order placed by a buyer.

Turning specifically to the network-based publisher 102, an application program interface (API) server 118 and a web server 120 are coupled to, and provide programmatic and web interfaces respectively to, one or more application servers 122. The application servers 122 host a publication application 124 and an alternative fulfillment application 130. The application servers 122 are, in turn, shown to be coupled to one or more database server(s) 126 that facilitate access to one or more database(s) 128.

In one embodiment, the web server 120 and the API server 118 communicate about and receive data pertaining to listings, transactions, order tracking information, and feedback, among other things, via various user input tools. For example, the web server 1120 may send and receive data to and from a toolbar or webpage on a browser application (e.g., web client 110) operating on a client machine (e.g., client machine 106). The API server 118 may send and receive data to and from an application (e.g., client application 110 or shipping carrier application 116) running on another client machine (e.g., shipping carrier server 132).

The publication application 124 may provide a number of publisher functions and services (e.g., listing, payment, etc.) to users that access the network-based publisher 102. For example, the publication application 124 may provide a number of services and functions to users for listing goods and/or services for sale, facilitating transactions, and reviewing and providing feedback about transactions and associated users. The publication application 124 may further provide a shipment status related to a transaction.

The alternative fulfillment application 130 detects whenever an order is experiencing an issue by observing shipment tracking information or via another notification method. If a delay or loss is detected, the alternative fulfillment application 130 will check with a predefined list of alternative sellers and/or local stores to replace the buyer's order under the same order criteria, and within the same delivery estimate timeframe. Embodiments of the alternative fulfillment application 130 are further described below.

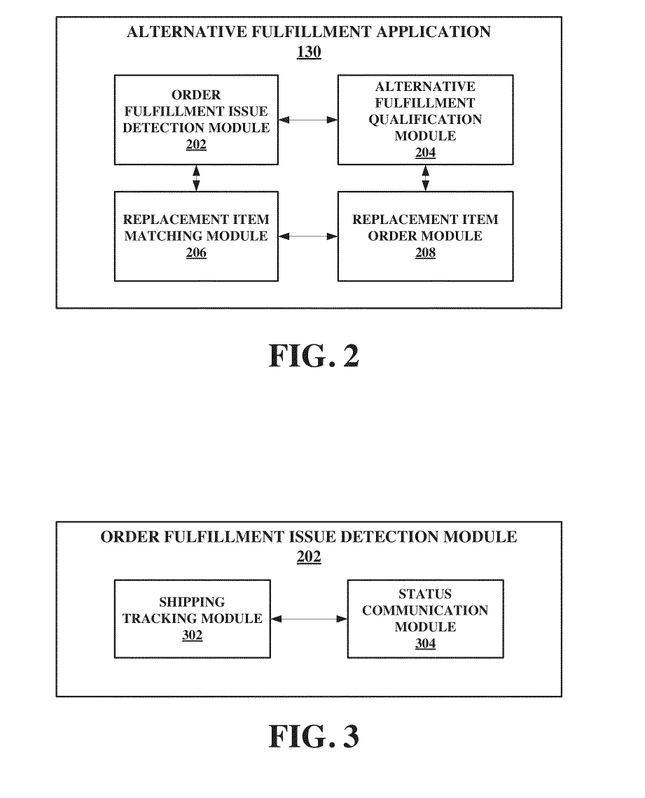

FIG. 2 is a block diagram illustrating an example embodiment of the alternative fulfillment application 130. The alternative fulfillment application 130 includes, for example, an order fulfillment issue detection module 202, an alternative fulfillment qualification module 204, a replacement item matching module 206, and a replacement item order module 208.

The order fulfillment issue detection module 202 detects a fulfillment delay of an item in an order placed in an online marketplace (e.g., publication application 124 of FIG. 1). The fulfillment delays include, for example, a shipping delay of the item, the item being lost during shipping, or the item being unable to be fulfilled.

The alternative fulfillment qualification module 204 determines whether the fulfillment delay qualifies for an alternative fulfillment order. The system can detect if an order is experiencing an issue by observing shipment tracking information from a third-party shipping carrier or from a notification status.

If a delay or loss is detected, the replacement item matching module 206 determines a replacement item for the item. In other words, the replacement item matching module 206 checks with a predefined list of alternative sellers and local physical stores to determine whether to replace the original's buyer's order under the same order criteria and within the same delivery estimate timeframe. Upon confirming the availability of alternative fulfillment options, the system may inquire the buyer for approval to allow a different source to fulfill their order. The replacement order would have some fixed variables. However, the buyer could have some flexibility to customize their replacement order.

Once the approval is submitted to the system from the buyer, the replacement item order module 208 cancels the order and replaces the order with the alternative fulfillment order for the replacement item. The system would then communicate the arrangements or specifics of the alternative order to the selected alternative seller or local physical store to fulfill the replacement order.

FIG. 3 is a block diagram illustrating an example embodiment of the order fulfillment issue detection module 202. In one embodiment, the order fulfillment issue detection module 202 includes a shipping tracking module 302 and a status communication module 304.

The shipping tracking module 302 analyzes shipping tracking information of the item to determine a delay in the delivery. In one embodiment, the shipping tracking module 302 communicates with the shipping carrier application 116 of the shipping carrier server 132 to retrieve a status of the shipment of the item from the original order placed by the buyer with the publication application 124. Those of ordinary skill in the art will recognize that the alternative fulfillment application 130 may include an API to communicate with the shipping carrier application 116. In one embodiment, the shipping carrier application 116 may be configured to generate a notification of a delay of the delivery of the item to the shipping tracking module 302.

In another embodiment, the shipping tracking module 302 may also be configured to determine whether the item has been lost during shipping or otherwise has not been or cannot be fulfilled.

The status communication module 304 monitors a status inquiry for the item from a buyer, a seller, or a customer service representative of the online marketplace. For example, the status communication module 304 may determine any shipping status inquiry from the buyer to the seller with respect to the shipment of the item. In another example, the status communication module 304 may determine that the seller has contacted the customer service of the online marketplace of the publication application 124 about a shipping delivery issue.

Thus, the order fulfillment issue detection module 202 determines the fulfillment delay of the item based on the shipping status of the item and/or the status inquiry for the item.

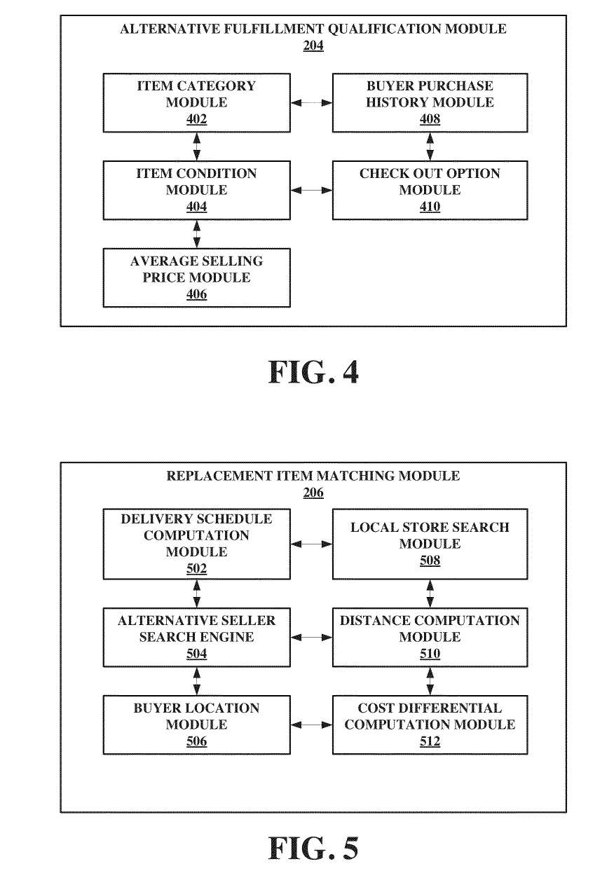

FIG. 4 is a block diagram illustrating an example embodiment of the alternative fulfillment qualification module 204. In one embodiment, the alternative fulfillment qualification module 204 includes an item category module 402, an item condition module 404, an average selling price module 406, a buyer purchase history module 408, and a check out option module 410.

The item category module 402 determines a category of the item. For example the item may belong to an electronic or apparel category.

The item condition module 404 determines a condition of the item. For example, the item condition module 404 determines whether the item ordered is new, used, or refurbished.

The average selling price module 406 determines an average selling price of the item. For example, the average selling price module 406 may calculate the average selling price of the item from other sellers of the online marketplace selling the same item.

The buyer purchase history module 408 analyzes a purchase history of a buyer of the item in the online marketplace. For example, the purchase history of the buyer may include how many times or how often the buyer has purchased the same item from the same seller or other sellers.

The check out option module 410 determines a check out option for the order in the online marketplace. For example, the check out option module 410 determines whether the buyer has selected expedited shipping or whether the order constitutes a gift.

The alternative fulfillment qualification module 204 determines whether the fulfillment delay qualifies for an alternative fulfillment order based on the category of the item, the condition of the item, the average selling price of the item, the purchase history of the buyer, and the check out option of the order. For example, if the buyer has ordered a digital camera that is available from other sellers in the same condition new or used) and the average selling price of the digital camera is about the same as what the buyer has paid for in the original order, the buyer may be eligible for an alternative fulfillment order should there be an issue with the original order. In another example, if the buyer has selected an expedited shipping option in the original order, the alternative sellers would need to meet the same criteria for the expedited shipping so that the item could be replaced by the same estimated delivery date of the original order.

The alternative fulfillment qualification module 204 determines if an order qualifies for an alternative fulfillment so to maximize chances of matching alternate items, to maximize buyer retention, and to maximize the online marketplace benefit.

FIG. 5 is a block diagram illustrating an example embodiment of the replacement item matching module 206. The replacement item matching module 206 includes, for example, a delivery schedule computation module 502, an alternative seller search engine 504, a buyer location module 506, a local store search module 508, a distance computation module 510, and a cost differential computation module 512.

The delivery schedule computation module 502 calculates a time needed for an on-schedule delivery to a buyer of the item in the order. For example, the delivery schedule computation module 502 determines how much time is left from the time the shipping issue has been flagged by the order fulfillment issue detection module 202 to the delivery estimated time from the original order.

The alternative seller search engine 504 evaluates alternative setters with inventory matching the item and shipping criteria, matching the order. For example, the alternative seller search engine 504 determines which alternative sellers have the same item in stock and are able to ship and deliver to the buyer by the original estimated delivery date of the original order. In another embodiment, the alternative seller search engine 504 may determine which alternative sellers can deliver the same item (regardless of whether they have it in stock at the moment) to the buyer at about the original estimated delivery date of the original order. In another example, the alternative seller search engine 504 may search for sellers that are capable of matching the shipping criteria of the original order. In other words, an alternative seller needs to be capable of expedited shipping when the checkout option of the original order indicates that the item needs to be shipped in an expedited manner.

The buyer location module 506 identifies a location of the buyer. For example, the buyer location module 506 determines the delivery address of the buyer from the original order placed on the online marketplace. In another embodiment, the location of the buyer may include a mailing address of the buyer, a billing address of the buyer, a work address of the buyer, or an address of a recipient of the item.

The local store search module 508 searches for physical stores of the alternative sellers within a predetermined distance from the location of the buyer with inventory matching the item. For example, the local store search module 508 searches for local physical store within a 10-mile radius of the delivery address specified by the buyer.

The distance computation module 510 calculates a distance between the location of the buyer and the location of the alternative sellers, and a distance between the location of the buyer and the location of the physical stores of the alternative sellers. For example, the distance computation module 510 calculates the distance between the buyer and the shipping source of the seller. The shipping source of the seller may be the physical address from which the seller is shipping the item. In another example, the distance computation module 510 calculates the distance between the buyer and a physical store of an alternative seller nearby.

The cost differential computation module 512 calculates a cost difference between the order and the alternative fulfillment order. For example, the cost difference between the order and the alternative fulfillment order may be due to the price difference between the original seller and the alternative seller and the different shipping costs between the original seller and the alternative seller. The original seller may use a different shipping carrier from the alternative seller.

The replacement item matching module 206 determines the replacement item for the item from an alternative seller based on the time needed for an on-schedule delivery to the buyer, availability of alternative sellers with inventory and shipping criteria, matching the order, the location of the buyer, physical stores of the alternative sellers within the predetermined distance from the location of the buyer with inventory matching the item, the distance between the location of the buyer and the location of the alternative sellers, the distance between the location of the buyer and the location of the physical stores of the alternative sellers, and the cost difference between the order and the alternative fulfillment order. For example, the replacement item matching module 206 may determine that the same item can be picked up from a local physical store for about the same price as the original order. In another example, the replacement item matching module 206 may determine that the same item can be delivered to the buyer by the original estimated delivery date for about the same price as the original order.

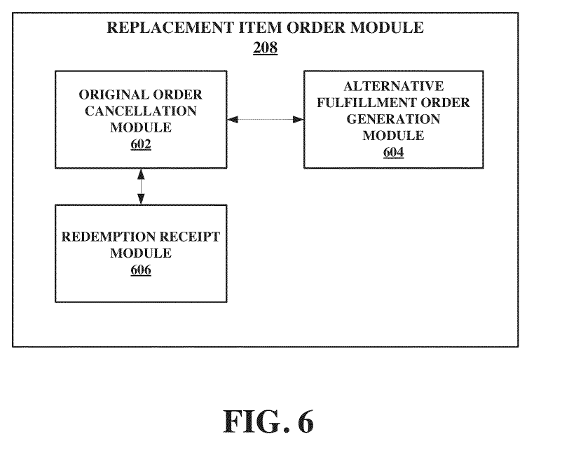

FIG. 6 is a block diagram illustrating an example embodiment of the replacement item order module 208. The replacement item order module 208 includes, for example, an original order cancellation module 602, an alternative fulfillment order generation module 604, and a redemption receipt module 606.

The original order cancellation module 602 cancels the order. The alternative fulfillment order generation module 604 generates the alternative fulfillment order for the replacement item. In one embodiment, the original order cancellation module 602 recoups hinds from the original seller. The redemption receipt module 606 generates a redemption receipt to the buyer for the buyer to pick up the replacement item from a local physical store of an alternative seller of the replacement item. The redemption receipt may include, for example, a machine-readable code to be scanned at the local physical store to redeem the item. The redemption receipt module 606 may also notify the local physical store of the machine-readable code associated with the alternative fulfillment order.

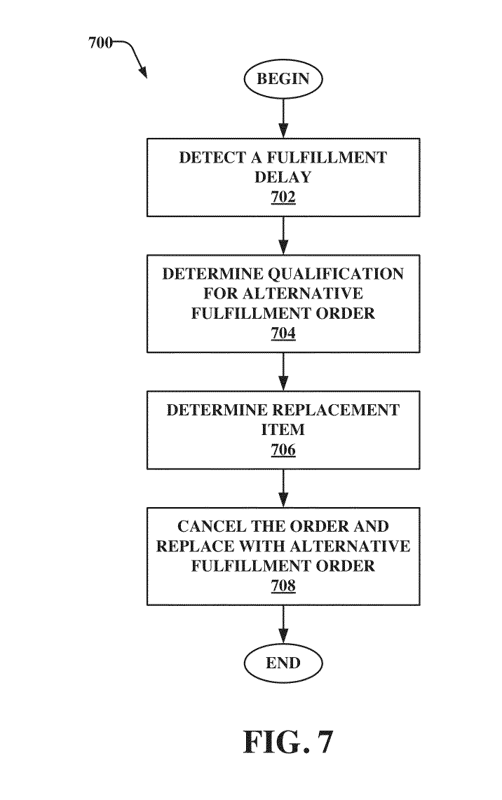

FIG. 7 is a flow chart 700 of one embodiment of a method for providing an alternative fulfillment order. At 702, the alternative fulfillment application 130 detects a fulfillment delay of an item in an order placed in an online marketplace. At 704, the alternative fulfillment application 130 determines whether the fulfillment delay qualifies for an alternative fulfillment order. At 706, the alternative fulfillment application 130 determines a replacement item for the item. At 708, the alternative fulfillment application 130 cancels the order and replaces the order with the alternative fulfillment order for the replacement item.

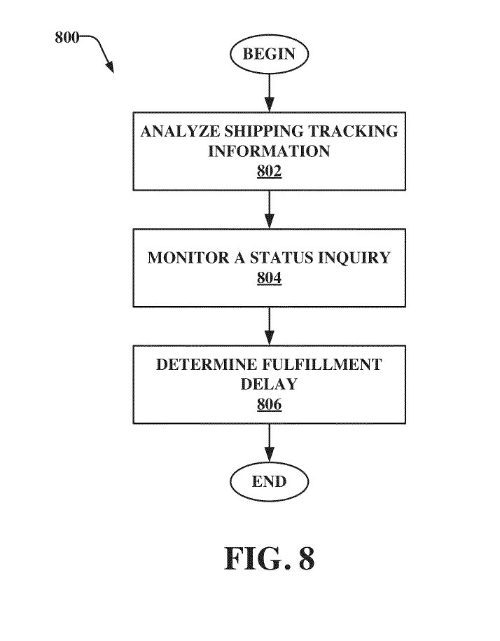

FIG. 8 is a flow chart 800 of one embodiment of a method for detecting an order fulfillment issue. At 802, the shipping tracking information of the item is analyzed. At 804, status inquiries for the item from a buyer, a seller, or a customer service representative of the online marketplace are monitored. At 806, the fulfillment delay of the item is determined based on the shipping status of the item or the status inquiry for the item.

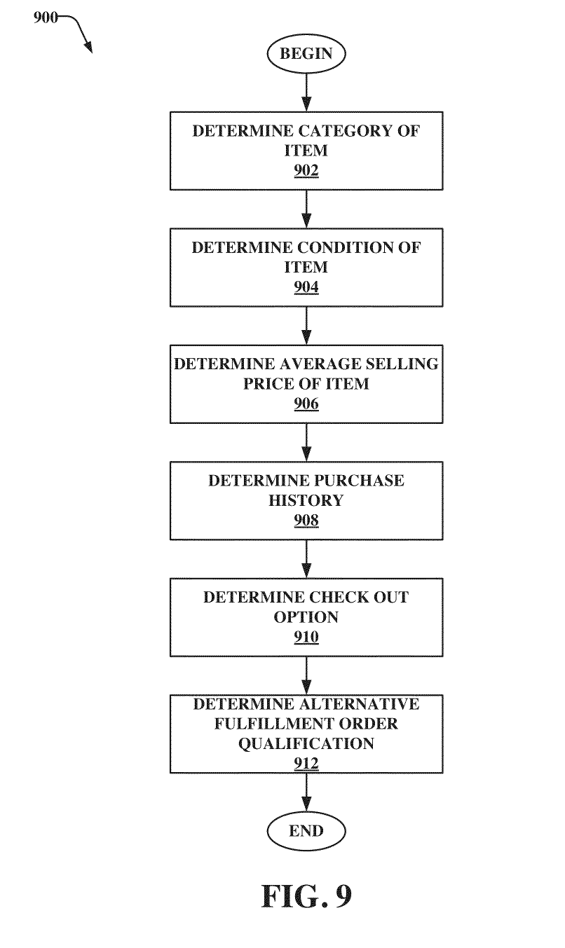

FIG. 9 is a flow chart 900 of one embodiment of a method for determining an alternative fulfillment qualification. At 902, a category of the item is determined. At 904, a condition of the item is determined. At 906, an average selling price of the item is determined. At 908, a purchase history of a buyer of the item in the online marketplace is determined. At 910, a check out option of the order in the online marketplace is determined. At 912, a determination is made as to whether the fulfillment delay qualifies for an alternative fulfillment order based on the category of the item, the condition of the item, the average selling price of the item, the purchase history of the buyer, and the check out option of the order.

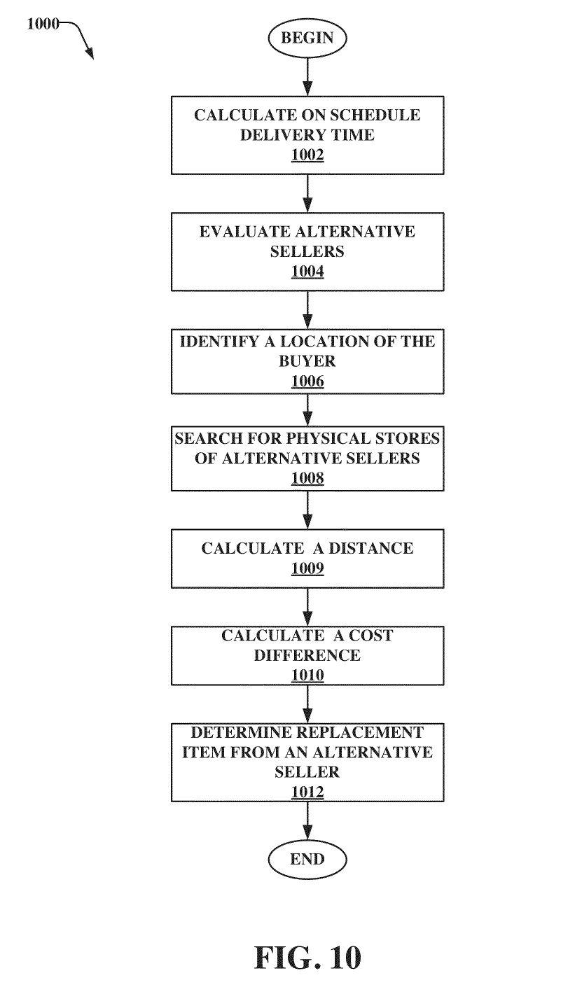

FIG. 10 is a flow chart 1000 of one embodiment of a method for determining matching replacement items. At 1002, a time needed for an on-schedule delivery to a buyer of the item in the order is calculated. At 1004, alternative sellers with inventory matching the item and shipping criteria matching the order are evaluated. At 1006, the location of the buyer is identified. At 1008, physical stores of the alternative sellers within a predetermined distance from the location of the buyer with inventory matching the item are searched for. At 1009, the distance between the location of the buyer and the location of the alternative sellers is calculated. In another embodiment, the distance between the location of the buyer and the location of the physical stores of the alternative sellers is calculated. At 1010, the cost difference between the order and the alternative fulfillment order is calculated. At 1012, the replacement item for the item from an alternative seller is determined based on the time needed for an on-schedule delivery to the buyer, alternative sellers with inventory and shipping criteria matching the order, the location of the buyer, the physical stores of the alternative sellers within the predetermined distance from the location of the buyer with inventory matching the item, the distance between the location of the buyer and the location of the alternative sellers, the distance between the location of the buyer and the location of the physical stores of the alternative sellers, and the cost difference between the order and the alternative fulfillment order.

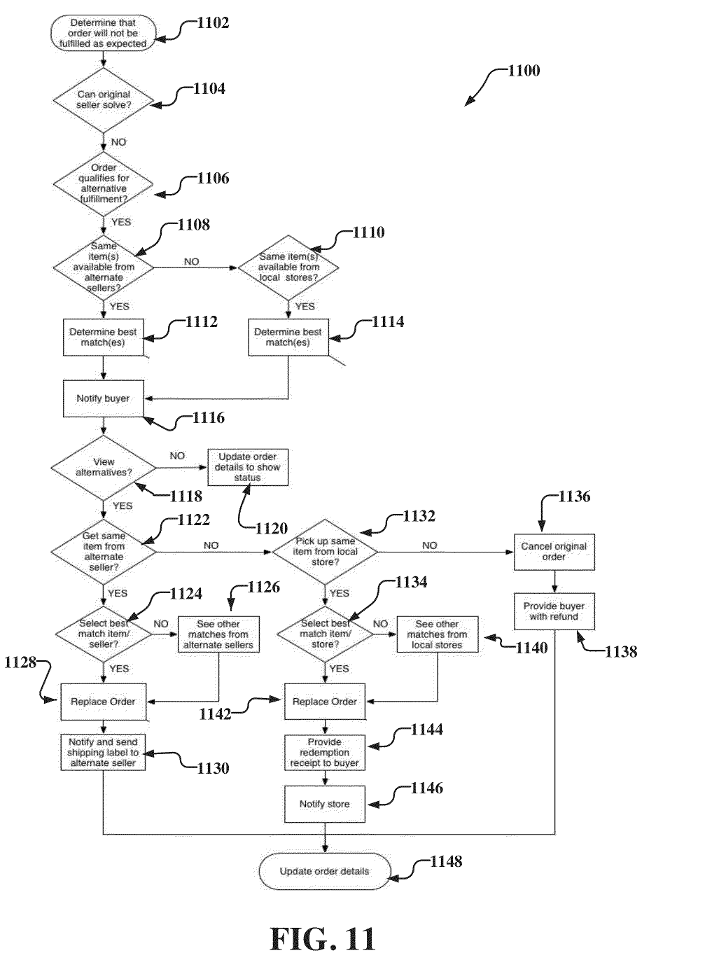

FIG. 11 is a flow chart 1100 of an example of a method for replacing an order with an alternative fulfillment order. At 1102, the alternative fulfillment application 130 determines that the order will not be fulfilled as expected. At 1104, the alternative fulfillment application 130 determines whether the regional seller can resolve the fulfillment issue. If the original seller cannot resolve the fulfillment issue, the order may qualify for an alternative fulfillment process at 1106. At 1108, the alternative fulfillment application 130 determines whether the same item from the order is available from alternative sellers. If the same item is available from alternative sellers, the alternative fulfillment application 130 determines the best match at 1112. If the same item is not available from alternative sellers at 1108, the alternative fulfillment application 130 determines whether the same item is available from local stores at 1110. At 1114, the alternative fulfillment application 130 determines the best matches from the local stores.

At 1116, the buyer is notified that the item is available from an alternative seller or from a local physical store to the buyer.

The buyer can decide to view the alternative option at 1118. If the buyer decides to proceed with the alternative order, the alternative fulfillment application 130 updates the order details to show the current status at 1120.

At 1122, the alternative fulfillment application 130 determines whether the same item is available from an alternative seller. If it is available, the alternative fulfillment application 130 determines whether the best match item has been selected from the seller at 1124. If the best item has been selected, the order is replaced at 1128. The alternative fulfillment application 130 notifies and send a shipping label to the alternate seller at 1130.

If there are no best match items from the seller at 1124, the alternative fulfillment application 130 looks for matches from alternative sellers at 1126.

If the buyer decides not to get same item from the alternative seller at 1122, the buyer has the option to pick up the same item from a local physical store at 1132. At 1134, the alternative fulfillment application 130 selects the best match item from the alternative local physical store. Once the item has been matched from the local physical store, the order is replaced at 1142. In one embodiment, the alternative fulfillment application 130 provides a redemption receipt to the buyer at 1144. At 1146, the alternative fulfillment application 130 notifies the local physical store of the replacement order generated at 1142.

If the buyer decides not to pick up the same item from a local physical store from an alternative seller at 1132, the alternative fulfillment application 130 cancels the original order at 1136 and provides the buyer a refund at 1138. At 1148, the order details are updated.

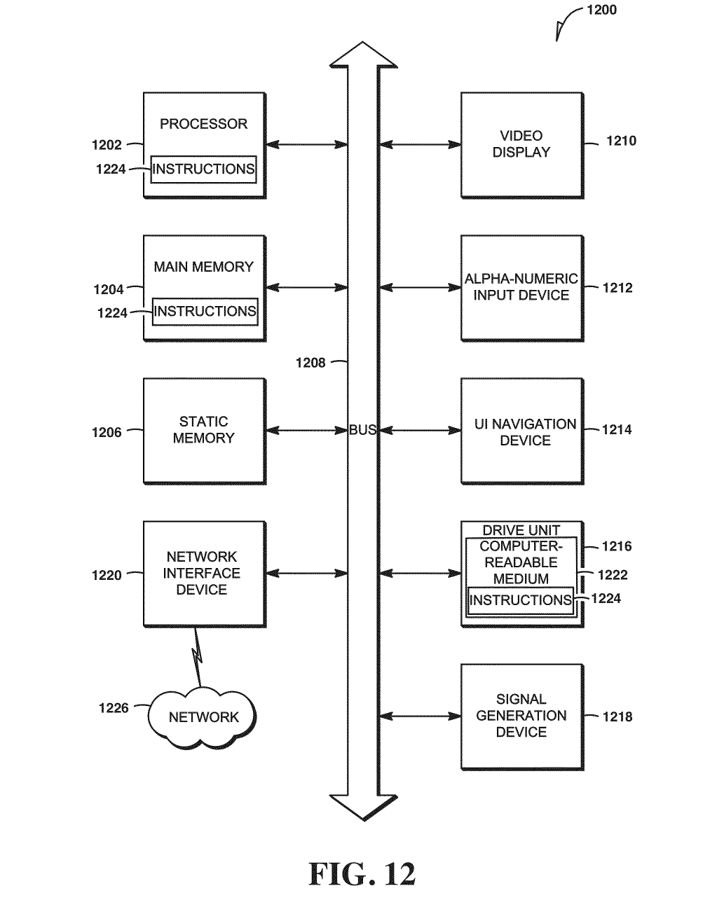

FIG. 12 shows a diagrammatic representation of a machine in the example form of a computer system 1200 within which a set of instructions may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a user interface (UI) navigation device 1214 (e.g., a mouse), a disk drive unit 1216, a signal generation device 1218 (e.g., a speaker) and a network interface device 1220.

The disk drive unit 1216 includes a machine-readable medium 1222 on which is stored one or more sets of instructions and data structures software 1224) embodying or utilized by any one or more of the methodologies or functions described herein. The software 1224 may also reside, completely or at least partially, within the main memory 1204 and/or within the processor 1202 during execution thereof by the computer system 1200, the main memory 1204 and the processor 1202 also constituting machine-readable media.

The software 1224 may further be transmitted or received over a network 1226 via the network interface device 1220 utilizing any one of a number of well-known transfer protocols (e.g., HTTP).

While the machine-readable medium 1222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present description or that is capable of storing, encoding or carrying data structures utilized by or associated with such a set of instructions. The term “machine-readable medium” shall accordingly be taken to include, but not be limited to, solid-state memories, optical media, and magnetic media.

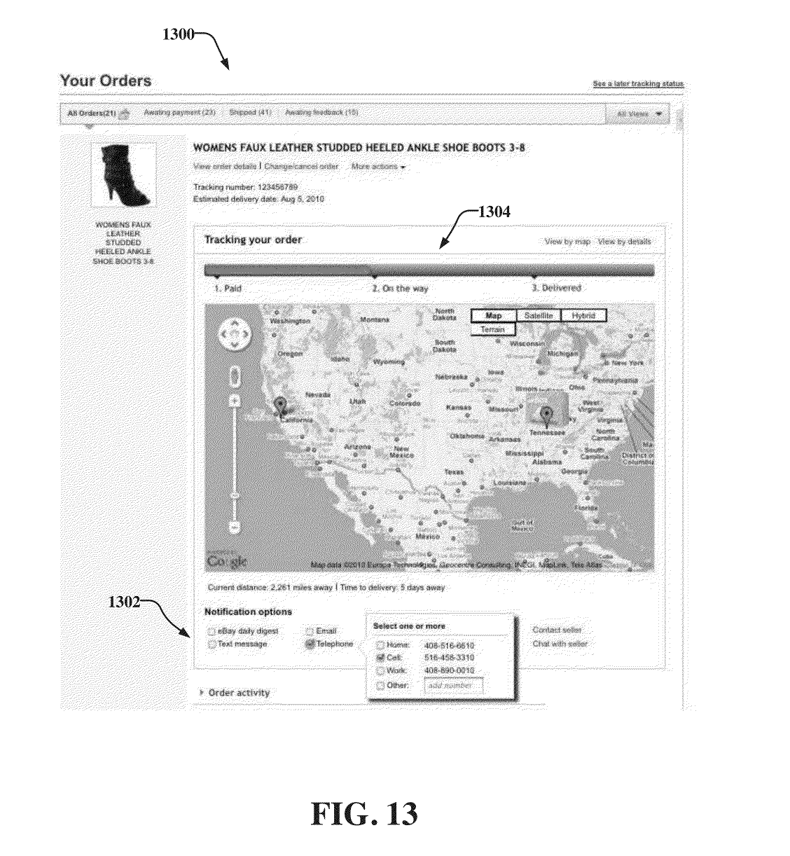

FIG. 13 is a screenshot of one embodiment of an order detail page 1300 with notification options 1302. The order detail page 1300 illustrates a tracking status 1304 of the order (e.g., paid, on the way, delivered). The notification options 1302 include contact options for the buyer to be notified of any fulfillment issues.

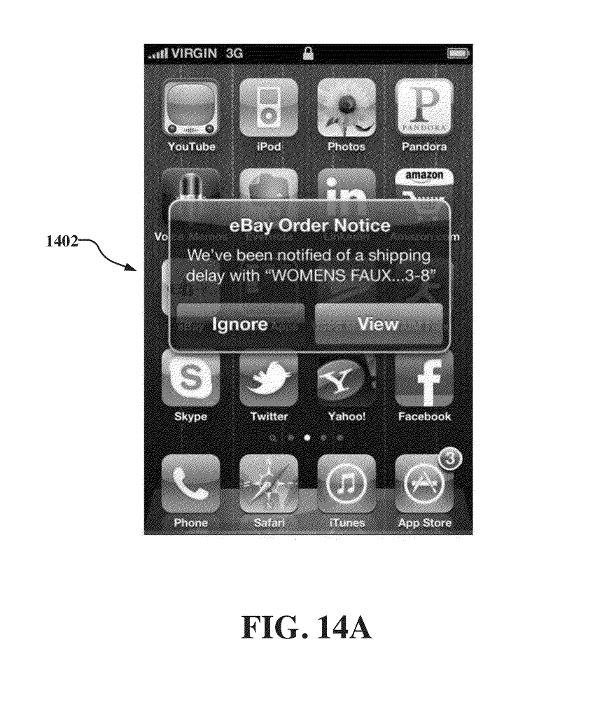

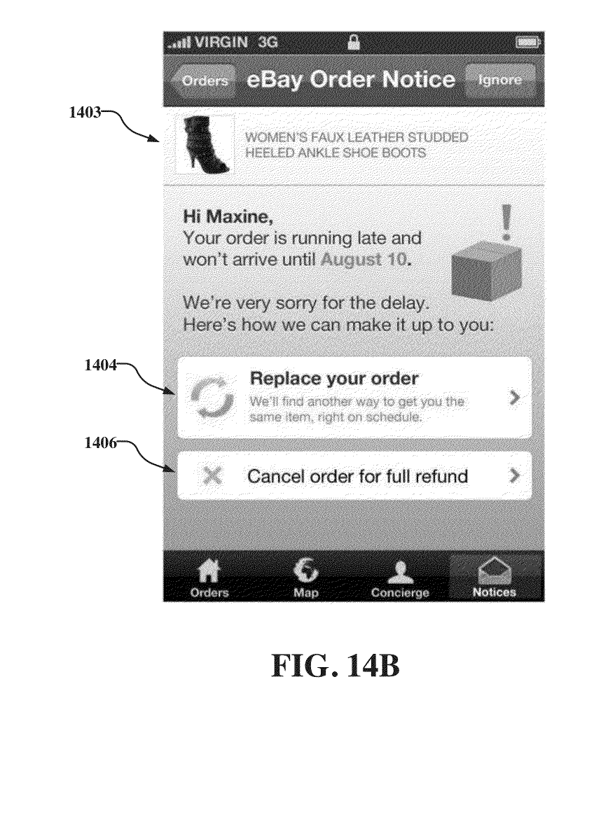

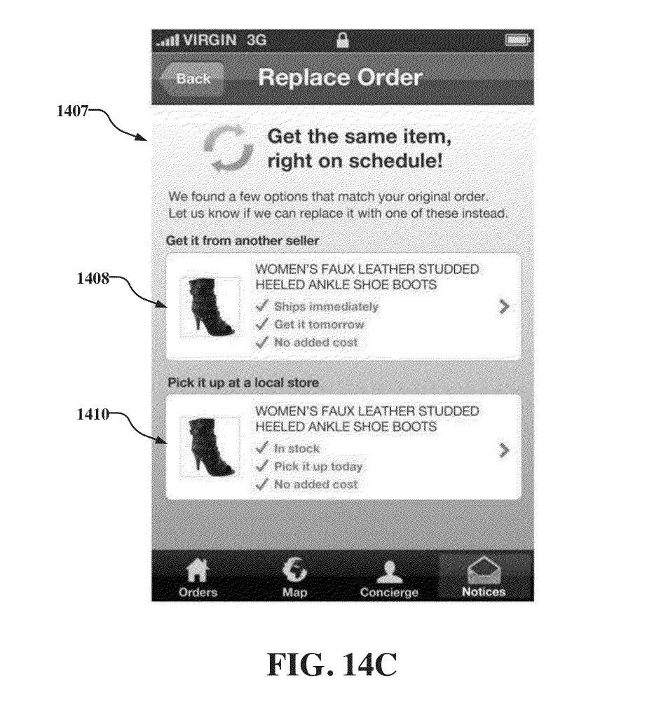

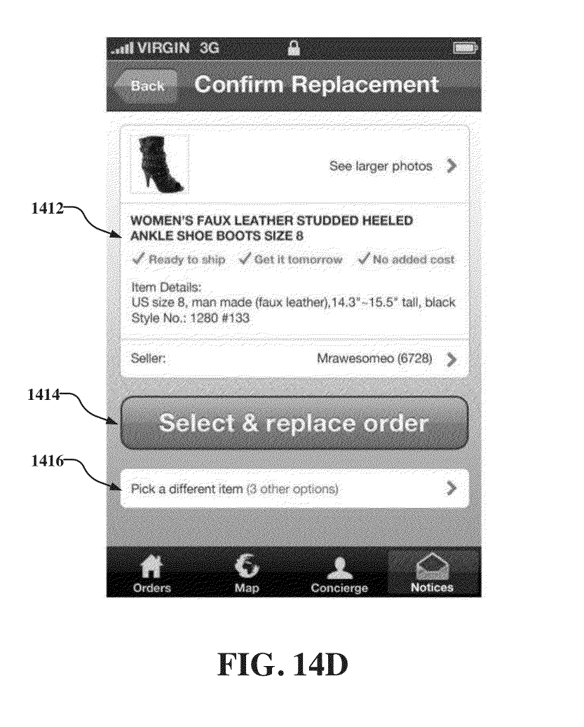

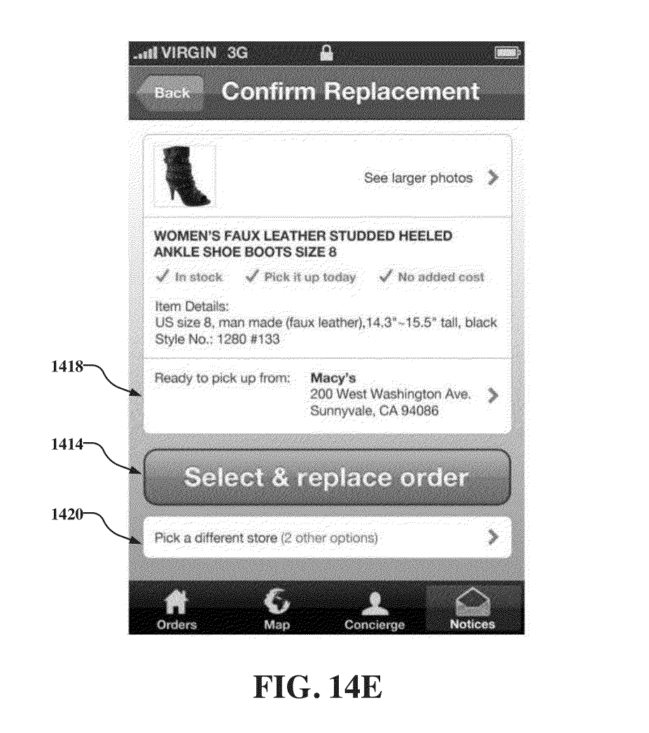

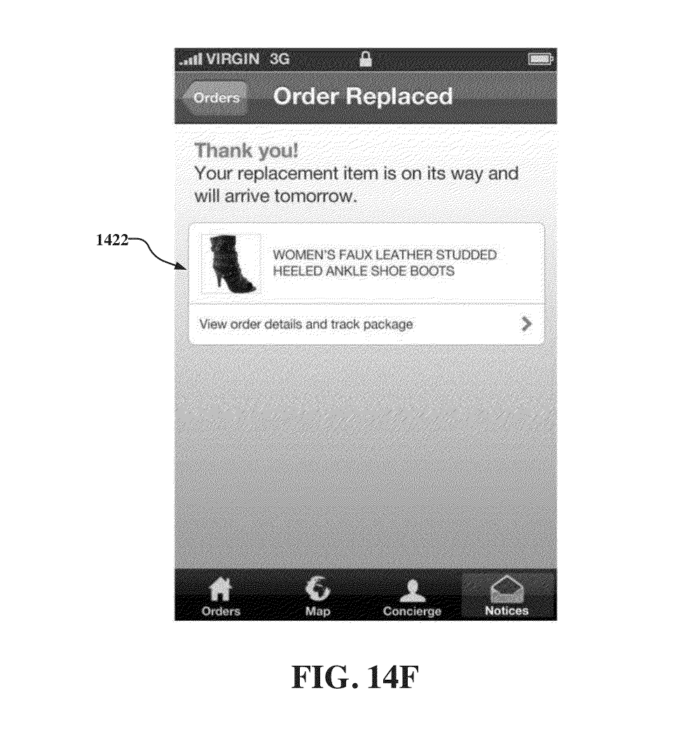

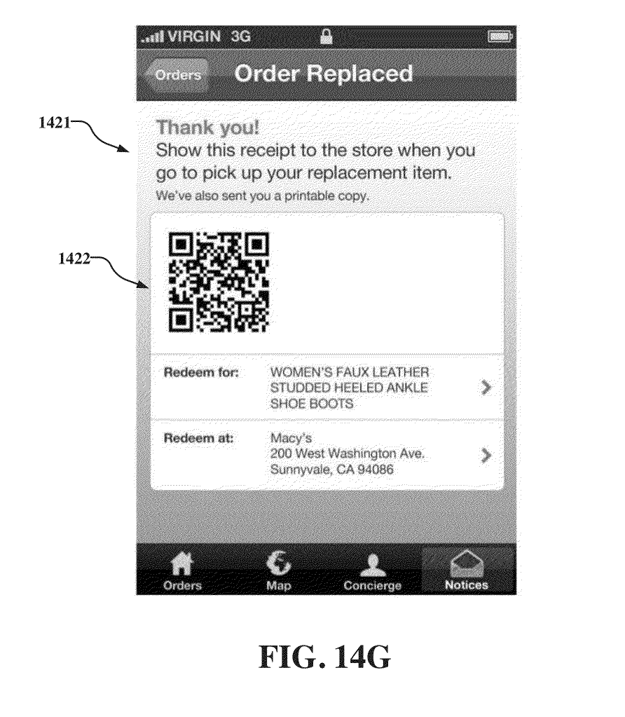

FIG. 14A is a screenshot of one embodiment of a notification 1402 of a shipping delay. The notification 1402 includes a notice of the shipment delay of an item from an order placed in the online marketplace.

FIG. 14B is a screenshot of an example order information screen 1403 with options for replacing or cancelling a delayed order. The order information screen explains that the order is being delayed and may indicate an approximate date of delivery. Two options are presented to the buyer: the first option 1404 allows the buyer to replace the order with an alternative fulfillment order. The second option 1406 allows the buyer to cancel the order for a full refund.

FIG. 14C is a screenshot of an example order replacement option screen 1407. The order replacement option screen 1407 allows the buyer to replace the original order from an alternative seller at 1408 or to pick up the same item from the original order at a local physical store from an alternative seller at 1410.

FIG. 14D is a screenshot of an example replacement information screen 1412 for an item to be shipped by an alternative seller. The replacement information screen 1412 includes a button 1414 for the buyer to select and replace the original order to be fulfilled by an alternative seller. In other words, the same item will be shipped from the alternative seller. The replacement information screen 1412 also includes an option 1416 for the buyer to select a different item.

FIG. 14E is a screenshot of an example of another replacement information screen 1418 for an item to be provided by a local physical store. The replacement information screen 1418 includes the button 1414 for the buyer to select and replace the original order to be fulfilled by a local physical alternative seller. The replacement information screen 1418 also includes an option 1420 for the buyer to select from a different store.

FIG. 14F is a screenshot of an example order replacement confirmation screen 1422 for an item the user has selected to be provided by an alternative seller. The buyer has the option to view the order details and track the shipping status of the alternative fulfillment order.

FIG. 14G is a screenshot of an example order replacement confirmation receipt 1421 for an item to be picked up at a local physical store. The order replacement confirmation receipt 1421 includes, for example, a machine-readable code 1422 to be presented at the local physical store. The order replacement confirmation receipt 1421 also includes a description of the item to be redeemed and a location of where the item is to be redeemed.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system, comprising:
a processor-implemented order fulfillment issue detection module configured to detect a fulfillment delay of an item in an order placed in an online marketplace;
a processor-implemented alternative fulfillment qualification module configured to determine whether the item associated with the fulfillment delay qualifies for an alternative fulfillment order;
a processor-implemented replacement item matching module configured to determine a replacement item for the item; and
a processor-implemented replacement item order module configured to cancel the order and replace the order with the alternative fulfillment order for the replacement item.

2. The system of claim 1, wherein the fulfillment delay comprises a shipping delay of the item, the item being lost during shipping, or the order cannot be fulfilled.

3. The system of claim 1, wherein the processor-implemented order fulfillment issue detection module further comprises:
a shipping tracking module configured to analyze shipping tracking information of the item; and
a status communication module configured to monitor a status inquiry for the item from a buyer, a seller, or a customer service representative of the online marketplace;
wherein the processor-implemented order fulfillment issue detection module determines the fulfillment delay of the item based on the shipping status of the item or the status inquiry for the item.

4. The system of claim 1, wherein the processor-implemented alternative fulfillment qualification module comprises:
an item category module configured to determine a category of the item;
an item condition module configured to determine a condition of the item;
an average selling price module configured to determine an average selling price of the item;
a buyer purchase history module configured to determine a purchase history of a buyer of the item in the online marketplace; and
a check out option module configured to determine a check out option of the order in the online marketplace,
wherein the processor-implemented alternative fulfillment qualification module determines whether the fulfillment delay qualifies for an alternative fulfillment order based on the category of the item, the condition of the item, the average selling price of the item, the purchase history of the buyer, or the check out option of the order.

5. The system of claim 1, wherein the processor-implemented replacement item matching module comprises:
a delivery schedule computation module configured to calculate a time needed for an on-schedule delivery to a buyer of the item in the order;
an alternative seller search engine configured to evaluate alternative sellers with inventory matching the item and shipping criteria matching the order;
a buyer location module configured to identify a location of the buyer;
a local store search engine configured to search for physical stores of the alternative sellers within a predetermined distance from the location of the buyer with inventory matching the item;
a distance computation module configured to calculate a distance between the location of the buyer and the location of the alternative sellers, and a distance between the location of the buyer and the location of the physical stores of the alternative sellers;
a cost differential computation module configured to calculate a cost difference between the order and the alternative fulfillment order; and
wherein the processor-implemented replacement item matching module determines the replacement item for the item from an alternative seller based on the time needed for an on-schedule delivery to the buyer, alternative sellers with inventory and shipping criteria matching the order, the location of the buyer, physical stores of the alternative sellers within the predetermined distance from the location of the buyer with inventory matching the item, the distance between the location of the buyer and the location of the alternative sellers, the distance between the location of the buyer and the location of the physical stores of the alternative setters, or the cost difference between the order and the alternative fulfillment order.

6. The system of claim 1, wherein the processor-implemented replacement item order module comprises:
an original order cancellation module configured to cancel the order; and
an alternative fulfillment order generation module configured to generate the alternative fulfillment order for the replacement item.

7. The system of claim 6, wherein the alternative fulfillment order generation module comprises:
a redemption receipt module configured to generate a redemption receipt to the buyer for the buyer to pick up the replacement item from a local physical store of an alternative seller of the replacement item.

8. A computer-implemented method comprising:
detecting a fulfillment delay of an item in an order placed in an online marketplace at a processor-implemented order fulfillment issue detection module;
determining whether the item associated with fulfillment delay qualifies for an alternative fulfillment order at a processor-implemented alternative fulfillment qualification module;
determining a replacement item for the item at a processor-implemented replacement item matching module; and
canceling the order and replacing the order with the alternative fulfillment order for the replacement item at a processor-implemented replacement item order module.

9. The computer-implemented method of claim 8, wherein the fulfillment delay comprises a shipping delay of the item, the item being lost during shipping, or the order cannot be fulfilled.

10. The computer-implemented method of claim 8, wherein detecting comprises:
analyze shipping tracking information of the item;
monitoring a status inquiry for the item from a buyer, a seller, or a customer service representative of the online marketplace; and
determining the fulfillment delay of the item based on the shipping status of the item or the status inquiry for the item.

11. The computer-implemented method of claim 8, wherein determining whether the fulfillment delay qualifies for an alternative fulfillment order comprises:
determining a category of the item;
determining a condition of the item;
determining an average selling price of the item;
determining a purchase history of a buyer of the item in the online marketplace;
determining a check out option of the order in the online marketplace; and
determining whether the fulfillment delay qualifies for an alternative fulfillment order based on the category of the item, the condition of the item, the average selling price of the item, the purchase history of the buyer, or the check out option of the order.

12. The computer-implemented method of claim 8, wherein determining a replacement item for the item comprises:
calculating a time needed for an on-schedule delivery to a buyer of the item in the order;
evaluating alternative sellers with inventory matching the item and shipping criteria matching the order;
identifying a location of the buyer;
searching for physical stores of the alternative sellers within a predetermined distance from the location of the buyer with inventory matching the item;
calculating a distance between the location of the buyer and the location of the alternative sellers, and a distance between the location of the buyer and the location of the physical stores of the alternative sellers;
calculating a cost difference between the order and the alternative fulfillment order; and
determining the replacement item for the item from an alternative seller based on the time needed for an on-schedule delivery to the buyer, alternative sellers with inventory and shipping criteria matching the order, the location of the buyer, the physical stores of the alternative sellers within the predetermined distance from the location of the buyer with inventory matching the item, the distance between the location of the buyer and the location of the alternative sellers, the distance between the location of the buyer and the location of the physical stores of the alternative sellers, or the cost difference between the order and the alternative fulfillment order.

13. The computer-implemented method of claim 8, wherein replacing the order comprises:
generating the alternative fulfillment order for the replacement item.

14. The computer-implemented method of claim 13 further comprising:
generating a redemption receipt to the buyer for the buyer to pick up the replacement item from a local physical store of an alternative seller of the replacement item.

15. A non-transitory computer-readable storage medium storing a set of instructions that, when executed by a processor, cause the processor to perform operations, comprising:
detecting a fulfillment delay of an item in an order placed in an online marketplace at a processor-implemented order fulfillment issue detection module;
determining whether the item associated with the fulfillment delay qualifies for an alternative fulfillment order at a processor-implemented alternative fulfillment qualification module;
determining a replacement item for the item at a processor-implemented replacement item matching module; and
canceling the order and replacing the order with the alternative fulfillment order for the replacement item at a processor-implemented replacement item order module.

16. The non-transitory computer-readable storage medium of claim 15, wherein the fulfillment delay comprises a shipping delay of the item, the item being lost during shipping, or the order cannot be fulfilled.

17. The non-transitory computer-readable storage medium of claim 15, wherein detecting comprises:
analyzing shipping tracking information of the item;
monitoring a status inquiry for the item from a buyer, a seller, or a customer service representative of the online marketplace; and
determining the fulfillment delay of the item based on the shipping status of the item or the status inquiry for the item.

18. The non-transitory computer-readable storage medium of claim 15, wherein determining whether the fulfillment delay qualifies for an alternative fulfillment order comprises:
determining a category of the item;
determining a condition of the item;
determining an average selling price of the item;
determining a purchase history of a buyer of the item in the online marketplace;
determining a check out option of the order in the online marketplace; and
determining whether the fulfillment delay qualifies for an alternative fulfillment order based on the category of the item, the condition of the item, the average selling price of the item, the purchase history of the buyer, or the check out option of the order.

19. The non-transitory computer-readable storage medium of claim 1, wherein determining a replacement item for the item comprises:
calculating a time needed for an on-schedule delivery to a buyer of the item in the order;
evaluating alternative sellers with inventory matching the item and shipping criteria matching the order;
identifying a location of the buyer;
searching for physical stores of the alternative setters within a predetermined distance from the location of the buyer with inventory matching the item;
calculating a distance between the location of the buyer and the location of the alternative sellers, and a distance between the location of the buyer and the location of the physical stores of the alternative sellers;
calculating a cost difference between the order and the alternative fulfillment order; and
determining the replacement item for the item from an alternative seller based on the time needed for an on-schedule delivery to the buyer, alternative sellers with inventory and shipping criteria matching the order, the location of the buyer, the physical stores of the alternative sellers within the predetermined distance from the location of the buyer with inventory matching the item, the distance between the location of the buyer and the location of the alternative sellers, the distance between the location of the buyer and the location of the physical stores of the alternative sellers, or the cost difference between the order and the alternative fulfillment order.

20. The non-transitory computer-readable storage medium of claim 1, wherein replacing the order comprises:
generating the alternative fulfillment order for the replacement item; and
generating a redemption receipt to the buyer for the buyer to pick up the replacement item from a local physical store of an alternative seller of the replacement item.
